(19) United States
(12) Patent Application Publication
(10) Pub. No.: US 2006/0036015 A1
(43) Pub. Date: Feb. 16, 2006

(54) Conductive/dissipative plastic compositions for molding articles

(76) Inventors: Zuo Yi, Shan Xi Province (CN); Zhang Zun Chang, Shan Xi Province (CN); Darien R. Spencer, Hong Kong (HK)

Correspondence Address: Isabelle R. McAndrews;Peak International, 38507 Cherry Street, Unit G, Newark, CA, 94560-4743, US

(21) Appl. No.: 11/252,073

(22) Filed: Oct. 17, 2005

Related U.S. Application Data
(62) Division of application No. 10/900,854, filed on Jul. 27, 2004.
(60) Provisional application No. 60/575,214, filed on May 27, 2004.

(51) Int. Cl. C08K 3/40; C08K 3/04

(52) U.S. Cl. 524/494; 524/495

(57) ABSTRACT

A conductive plastic composition comprises a polymeric resin or mixture of polymeric resins; glass fiber; carbon power; and antioxidant. Molding articles formed in accordance with the present invention have an improved shrinkage ratio and surface resistivity. The molding articles of this invention can be used for electrostatic dissipation or antistatic purposes in packages, electronic components, and storage trays. Also disclosed is a method of fabricating a tray comprising molding the composition of the present invention.

### RELATED APPLICATIONS

This application claims the benefit of provisional application 60/575,214 filed on May 27, 2004, and nonprovisional application Ser. No. 10/900,854, filed on Jul. 27, 2004.

### BACKGROUND OF THE INVENTION

The traditional method for forming electrostatic dissipative articles is by combining a polymeric resin with carbon fibers, and carbon powder. However, these compositions are characterized by an undesirable shrinkage rate and variable surface properties.

### SUMMARY OF THE INVENTION

The present invention relates to compositions comprising polymeric resins, glass fiber, carbon powder and antioxidant. The compositions are injection molded to form molded articles having conductive, dissipative and antistatic properties suitable for storage trays, including trays for storing electronic components such as circuit boards, semiconductor devices, and bare dies. Molding articles formed in accordance with the present invention exhibit an improvement in the shrinkage rate and surface resistivity compared to molding articles in the prior art. The molding articles of this invention also exhibit excellent mechanical properties and superior baking performance. As a result, the molding articles made from these compositions can be used for electrostatic dissipation or antistatic purposes in packages, electronic components, and storage trays.

### BRIEF DESCRIPTION OF THE DRAWINGS

FIG. 1 is a plot of surface resistivity versus carbon powder content for the composition of Example 1.

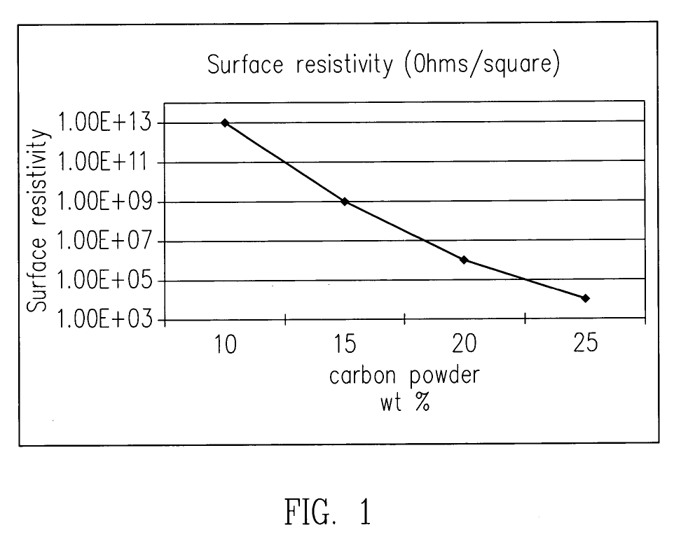

FIG. 2 is a plot of the shrinkage rate versus glass fiber content for the composition of Example 1.

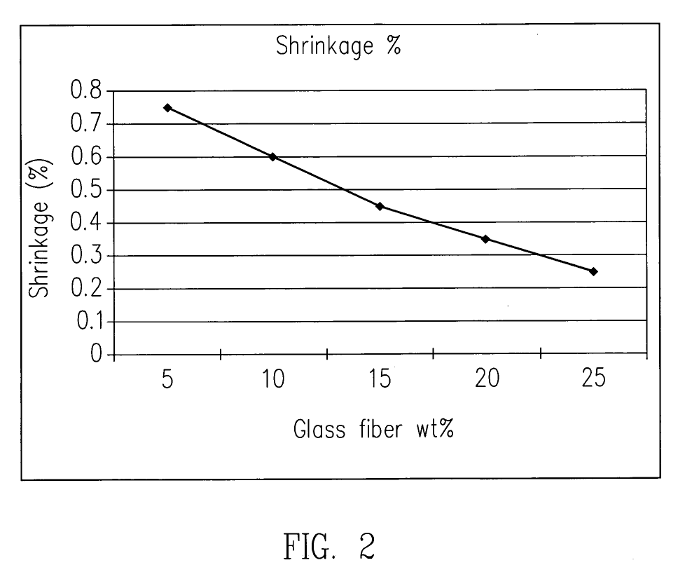

FIG. 3 is a process flow for manufacturing an IC tray with the composition of the present invention.

### DETAILED DESCRIPTION OF THE INVENTION

The conductive/dissipative composition of the present invention is composed of four main ingredients: (A) a polymeric resin or blend of polymeric resins; (B) glass fiber; (C) carbon power; and (D) antioxidant. The resin (A) is present from 40 to 70 wt %; each individual resin is present in a range from 0.5 to 95 wt %. Glass fiber (B) is present in amounts ranging from 0.1 to 50 wt %. Carbon Powder (C) is present from 10 to 35 wt %. Antioxidant (D) is added in small amounts in the composition—in amounts of up to 0.5 wt %. All amounts indicated herein are weight percents based on the total weight of the composition unless otherwise indicated. A suitable antioxidant would include Irganox 245 which is available from Ciba Specialty Chemicals. Other additives may be included in the composition including stabilizers, impact modifiers, and polymerization catalysts. The compositions of the present invention exclude the use of vaporized carbon fibers. In preferred embodiments of the invention, carbon fibers are omitted altogether.

The polymeric resin may be selected from a wide variety of thermoplastic resins and blends of thermoplastic resins. Polymeric resins suitable for the present invention include acrylonitrile-butadiene-styrene, polystyrene or a high impact styrene (HIPS), polyethylene, polycarbonate, polypropylene, polyphenylene ether, polybutylene terephthalate, polysulphone, polyether ether ketone, polyether imide, styrene-butadiene-styrene copolymer, hydrogenated styrene-butadiene-styrene copolymer (SEBS), polyethersulphone, polyphenylene sulfide, and mixtures comprised of any of the aforementioned suitable resins. The polystyrene resins and the styrene copolymers incorporated in this invention are atactic and thus have an amorphous morphology. Specific non-limiting examples of suitable mixtures of polymers include acrylonitrile-butadiene-styrene mixed with polycarbonate; polysulphone mixed with polycarbonate; and polyphenylene ether combined with polystyrene, polyethylene, and styrene-butadiene-styrene.

The glass fiber suitable for this invention is cut to between 3 mm to 12 mm in length. Preferably the glass fiber strands will be cut to a length that ranges between 3.2 and 6.4 mm inclusive. Most preferably the glass fibers will be cut to 4.5 mm in length. A suitable type of glass fiber for this invention is sold as Chop Vantage® 3786 glass fibers available from PPG Industries Inc., Pittsburgh Pa. Other types of glass fibers may also be used, including TGFS-183E sold by Taiwan Glass Industrial Company.

Carbon powder in this invention is conductive carbon powder having an average diameter ranging from 25 to 50 nm.

In the present invention a polymeric resin or resinous mixture is blended together for approximately 15 minutes and then compounded with glass fibers and carbon powder in a compounding machine, such as a twin screw extruder. The glass fibers and carbon powder are introduced at separate times in a side feeder into the main screw of the twin screw extruder, where they are compounded with the selected polymeric resin or polymeric resin blend. However, where a compounding machine is used having multiple feeders, ingredients (A)-(D) may be compounded together in the aforementioned weight percent amounts. Antioxidant(s) are premixed with the polymeric resin or resinous mixture prior to the compounding steps. Upon completion of the compounding an extrudate is produced which is cooled and pelletized. The preferred extrusion temperature range is 240-280° C. over a period ranging from 30-60 seconds in the barrel of the twin screw extruder. Other additives may be included in the composition including stabilizers, impact modifiers, and polymerization catalysts.

In a first preferred embodiment, a first composition comprising polymeric resin along with antioxidant is compounded with glass fiber at a compounding temperature ranging from 250° C. to 275° C. The polymeric resin (A) may be selected from any one of the thermoplastic resins or blends of thermoplastic resins previously identified as being suitable for the present invention. The polymeric resin (A) is present from 40 to 70 wt %, each individual resin is present in a range from 0.5 to 95 wt %.

A second composition comprised of polyphenylene ether or polycarbonate is then compounded with carbon powder at a temperature ranging from 240° C. to 260° C. in a twin screw extruder. The first and second compositions are then blended together in a standard industrial blender to yield the pelletized composition of the present invention.

An example of the first preferred embodiment is to form a first composition comprising a polymeric resin, such as ABS resin, mixed with antioxidant and then to compound the ABS mixture in a twin screw extruder with glass fiber at a temperature ranging from 250° C. to 275° C. Thereafter, a second composition comprising polycarbonate is compounded with carbon powder at a temperature ranging from 240° C. to 260° C. in a twin screw extruder. The first and second compositions are then blended together to yield compounded pellets. The first preferred embodiment is preferred in the situation where a compounding machine with one side feeder is used

In a second preferred embodiment, ingredients (A)-(D) [(A) a polymeric resin or blend of polymeric resins; (B) glass fiber; (C) carbon power; and (D) antioxidant] are mixed together, forming a mixture referred to herein as G4. Sixty percent of the G4 mixture is compounded with glass fiber in the twin screw extruder (hereinafter referred to as the first compounded composition). Compounding with glass fiber preferably occurs at a barrel temperature of 240° C. to approximately 260° C. Subsequently, 40% of the G4 mixture is compounded with carbon powder in the twin screw extruder (hereinafter referred to as the second compounded composition). Compounding with carbon powder preferably occurs at a barrel temperature of 250° C. to approximately 275° C. The first and second compounded compositions are then mixed together to form pellets suitable for an injection molding process.

Baking performance is determined by subjecting the molding articles to a baking test. A plurality of trays are stacked on top of each other and placed in an oven. The trays are baked at a temperature ranging from 125° C. to 150° C., and more preferably at 135° C. for approximately 24 hours. After the trays cool to room temperature, they are measured for tray warpage. If all trays within the stack pass warpage inspection, the trays are deemed to have also passed the baking test. Conversely, if any one of the trays in the stack fails warpage inspection, the trays are deemed to have failed the baking test. Individual trays are measured for warpage by placing a tray on a surface plate and inspecting 8 points on the underside of the try with a shim gauge that has a thickness of 30 mils. If the shim gauge can slide underneath one or more of the inspection points, the tray is rejected for being warped.

The pelletized composition formed at the end of the compounding process, after all compounded compositions are mixed together, is predried at 150° C. for a minimum of 4 hours inside the hopper of the injection molding machine. A mold attached to the barrel of the injection molding machine is pressure filled with the molding composition. The molded article or tray is cooled down and cleaned with a detergent to remove mold release agent from the molded article and then prerinsed and rinsed. The tray is annealed in an oven at temperatures ranging from 140° C. to 150° C., and preferably at 145° C. for a period of approximately 2 hours to relieve the build-up stress caused by the injection molding. Thereafter the trays are inspected for general appearance, warpage dimension characteristics, surface resistivity, shrinkage and other mechanical properties. If the trays pass quality assurance they are packed and shipped to the warehouse for storage.

The resulting IC trays exhibited excellent mechanical properties, including a stable shrinkage rate and superior baking performance. The IC trays were determined to have a surface resistivity between 10⁵ to 10¹¹ ohms/square.

### EXAMPLE 1

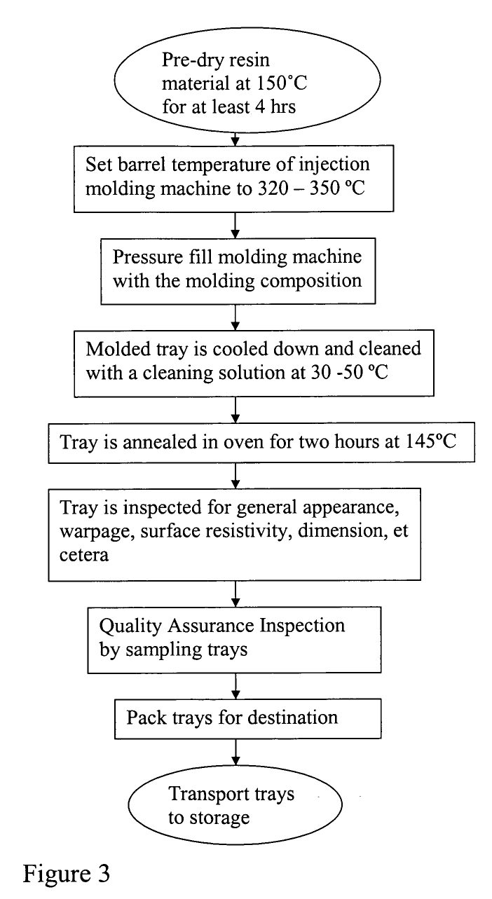

About 50 wt % of GPP13 (a blend of polyphenylene ether, polypropylene and polyethylene) was mixed with 0.14 wt % antioxidant and compounded with 18 wt % carbon powder first at a temperature ranging from 240° C.-260° C. and then compounded with 29 wt % glass fiber in a twin screw extruder at a temperature ranging from 250° C.-275° C. in accordance with the process flow shown in FIG. 5. The pelletized composition was injection molded into IC trays in accordance with the process flow shown in FIG. 3.

### EXAMPLE 2

A mixture of between 40-70 wt % of GPP13-R (a blend of polyphenylene ether, SEBS, and polyethylene) and 0.14 wt % antioxidant was compounded with 29 wt % glass fiber, and 18 wt % carbon powder in a twin screw extruder. The composition was compounded at a temperature of 275° C. The pelletized composition was injection molded into IC trays in accordance with the process flow shown in FIG. 3. The resulting IC trays had excellent mechanical properties, including a stable shrinkage rate and superior baking performance. The IC trays were determined to have a surface resistivity between 10⁵ to 10¹¹ ohms/square.

### EXAMPLE 3

Approximately 49 wt % of GPP5 (a blend of polycarbonate, acrylonitrile-butadiene-styrene, and HIPS) was compounded with 29 wt % glass fiber, 20 wt % carbon powder and 0.14 wt % antioxidant in a twin screw extruder. More specifically, 60% of the 49 wt % GPP5 was compounded with 29 wt % of glass fiber at a temperature of 275° C., and then 40% of the 49 wt % GPP5 was compounded with 20 wt % carbon powder at a temperature ranging from 240-260° C. The pelletized composition was injection molded into IC trays in accordance with the process flow shown in FIG. 3. The resulting IC trays had excellent mechanical properties, including a stable shrinkage rate and superior baking performance. The IC trays were determined to have a surface resistivity between 10⁵ to 10¹¹ ohms/square.

### EXAMPLE 4

A composition comprising 94.7 wt % polyphenylene ether resin, 0.3 wt % Irganox 245 as antioxidant with 5 wt % PPO resin (available as Noryl N300X from GE Plastics in Pittsfield, Mass. 01201) is blended together and then compounded at a temperature ranging from 240-275° C. in a twin screw extruder with 39 wt % glass fiber to obtain a first compounded composition. Then 70 wt % PPO resin is compounded at a temperature ranging from 240-260° C. in a twin screw extruder with 30 wt % carbon powder to obtain a second compounded composition. In this example, 74.5 wt % of the first compounded composition is mixed with 23.5 wt % of the second compounded composition, along with 1.5 wt % polypropylene and 0.5 wt % of polyethylene in a standard industrial blender for 15 minutes at room temperature. The resulting pelletized composition was injection molded into IC trays in accordance with the process flow shown in FIG. 3. The resulting IC trays had excellent mechanical properties, including a stable shrinkage rate and superior baking performance. The IC trays were determined to have a surface resistivity between 10⁵ to 10¹¹ ohms/square.

Table 1 compares the various properties of GPP13 (the composition described in Example 1 and covered by the present invention) with a prior art composition called PP3.

TABLE 1

| PROPERTY | GPP₁₃ | PP₃ |
|---|---|---|
| Tensile strength (psi) | 11500 | 8100 |
| Elongation (%) | 4.6 | 3 |
| Impact strength (notched) (Lb | 0.75 | 0.56 |
| ft/in) | | |
| Molding Shrinkage (%) | 0.22 | 0.78 |
| Heat Deflection Temperature | 170 | 155 |
| (° C.) | | |

PP3 is comprised of 20 wt % carbon powder and 80 wt % polyphenylene ether. PP3 does not contain any glass fibers in its composition. As can be seen from Table 1, GPP13 has excellent mechanical properties such as superior tensile and impact strength, superior elongation (%), as well has an improved shrinkage rate compared to the shrinkage rate of PP3. The shrinkage ratio of the molded articles will depend on the length of the molded article prior to annealing (A) and the length of the molded article after annealing (B). The shrinkage ratio is accordingly computed by subtracting the quantity (B divided by A) from A.

The examples described herein are solely representative of the present invention. It is understood that various modifications and substitutions may be made to the foregoing examples without departing from either the spirit or scope of the invention. In some instances certain features of the invention will be employed without other features depending on the particular situation encountered by the ordinary person skilled in the art. It is therefore the intent that the invention not be limited to the particular examples disclosed herein.

What is claimed is:

1. A molding composition comprising:
a) glass fiber;
b) carbon powder;
c) antioxidant;
d) a polymeric resin selected from the group consisting of polycarbonate, polysulphone, polyethersulphone, and mixtures thereof, wherein said molding composition is substantially free of vaporized carbon fibers.

2. The composition of claim 1 wherein the mixture of polymeric resins is selected from the group consisting of polysulphone mixed with polycarbonate.

3. The composition of claim 1 wherein the molding composition comprises 40 to 70 wt % polymeric resin, 0.1 to 50 wt % glass fiber, and 10 to 35 wt % carbon powder.

4. The composition of claim 2 wherein the mixture of polymeric resins comprises individual resins that are each present in ranges from 0.5 to 95 wt %.

5. The composition of claim 1, further comprising an impact modifier, and a stabilizer.

6. A method for manufacturing a conductive composition comprising:
a) compounding a first composition comprising polymeric resin, glass fibers, and an antioxidant in an extruder;
b) compounding a second composition comprising a polymeric resin and carbon powder;
c) pelletizing said first and second compositions together to form a pelletized material and injection molding said pelletized material into an article.

7. A tray for integrated circuits obtained by molding the resin composition of claim 1.

8. A molding composition comprising:
d) glass fiber;
e) carbon powder;
f) antioxidant;
d) a polymeric resin selected from the group consisting of polycarbonate, polysulphone, polyethersulphone, and mixtures thereof.

9. The composition of claim 8 wherein the molding composition comprises 40 to 70 wt % polymeric resin, 0.1 to 50 wt % glass fiber, and 10 to 35 wt % carbon powder.

10. The composition of claim 8 wherein the mixture of polymeric resins comprises individual resins that are each present in ranges from 0.5 to 95 wt %.

11. A tray for integrated circuits obtained by molding the resin composition of claim 8.

12. The tray of claim 11 having a surface resistivity between 10⁵. to 10¹¹ ohms/square.

13. The tray of claim 11 having a shrinkage ratio ranging from 0.25%-0.75%.

14. A tray obtained by molding the resin composition of claim 9, having a surface resistivity between 10⁵ to 10¹¹ ohms/square.

15. The tray of claim 14 having a shrinkage ratio ranging from 0.25%-0.75%.
